(19) United States
(12) Patent Application Publication
(10) Pub. No.: US 2009/0108762 A1
(43) Pub. Date: Apr. 30, 2009

(54) Lighting System

(75) Inventor: Tzu-Nan Chen, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei (TW)

(21) Appl. No.: 12/243,455

(22) Filed: Oct. 1, 2008

(30) Foreign Application Priority Data
Oct. 26, 2007 (CN) PCT/CN2007/003045

(51) Int. Cl. H05B 37/02; H05B 41/36

(52) U.S. Cl. 315/159; 315/291

(57) ABSTRACT

A lighting system is provided. Users can independently switch an ultrasonic detecting device in the lighting system between a disable mode and an enable mode. The lighting system, comprises: a light source for emitting a light; a detecting device for executing a detecting action to an object within a detectable zone of the detecting device; a control circuit, connected between the light source and the detecting device, for controlling the light source to emit the light according to the detecting action; and a trigger device, connected to the control circuit, for stopping the detecting device executing the detecting action in response to a trigger action when the detecting device is operating in an enable mode; or starting the detecting device to execute the detecting action in response to the trigger action when the detecting device is operating in a disable mode.

### CROSS-REFERENCE TO RELATED APPLICATIONS

This application is a continuation of PCT application no. PCT/CN2007/003045, filed Oct. 26, 2007.

### FIELD OF THE INVENTION

The present invention relates to a lighting system, and more particularly to a lighting system having a detecting device capable of operating the lighting system in an enable mode and a disable mode.

### BACKGROUND OF THE INVENTION

The light-emitting diode (LED) is capable of converting a forward current into light. In a forward-biased PN junction of the LED, minority carriers are injected across the junction and diffused into the P and N regions. The diffusing minority carriers then recombine with the majority carriers. Such recombination can be made to give rise to light emission.

LEDs are very popular devices. They can function as a light source for producing light in a variety colors and wavelengths. In an LED-lighting system, a variety colors can be produced and emitted through the allocation of LEDs having colors of Red-Green-Blue (RGB). Conventionally, controlling the intensity or color of the outputted light is usually made through an operation interface, such as a button or a knob. Today, an ultrasonic detecting device is implemented in the lighting system for controlling the LED to output light with a specific intensity or color.

FIG. 1A is a diagram showing a conventional lighting system adopting an ultrasonic detecting device for controlling the light source. As indicated, the lighting system 11 includes an ultrasonic detecting device 101. When an object 12, say, user's hand, enters a detectable zone of the ultrasonic detecting device 101, an ultrasonic wave, emitted from the ultrasonic detecting device 101, will be reflected by the object 12 and back to a receiver (not shown in FIG. 1A) within the ultrasonic detecting device 101. When the receiver detects the reflected ultrasonic wave, the distance R between the object 12 and the receiver is determined. According to the change of the distance R, the lighting system 11 generates a control signal for controlling the lighting system 11 to output light with a specific intensity or a specific color.

FIG. 1B is block diagram showing the conventional lighting system 11 depicted in FIG. 1A. As indicated, the lighting system 11 includes: the ultrasonic detecting device 101, a front-end processing circuit 102, a micro-processor 103, an LED driver 104, and an LED 105. When the ultrasonic wave, emitted from the ultrasonic detecting device 101, is reflected by the object 12 and back to the receiver within the ultrasonic detecting device 101, the ultrasonic detecting device 101 generates an object-distance signal, and then outputs the object-distance signal to the front-end processing circuit 102. After amplified and filtered by the front-end processing circuit 102, the processed object-distance signal is then transmitted to the micro-processor 103. The micro-processor 103 generates a control signal according to the processed object-distance signal, and then outputs the control signal to the LED driver 104. The LED driver 104 then drives the LED 105 to output light with a specific intensity or a specific color according to the control signal.

Basically, when users turn on the lighting system 11, the ultrasonic detecting device 101 accordingly is turned on. The ultrasonic detecting device 101 is not turned off until the lighting system is turned off. The LED 105 generally has a 100000-hour lifetime under a proper operation; however, the lifetime of the ultrasonic detecting device 101 is much shorter than that of the LED 105. In other words, the ultrasonic detecting device 101 is surely broken before the LED 15 is not worked. As a result, the lifetime of the lighting system 11 is shortened.

Therefore, there is a need to improve the drawbacks in the conventional lighting system.

### SUMMARY OF THE INVENTION

Therefore, by providing a trigger device, the detecting device of the lighting system can be switched between an enable mode and a disable mode, it follows that the detecting device can have a longer lifetime than that of the conventional lighting system.

The present invention discloses a lighting system, comprising: a light source for emitting a light; a detecting device for executing a detecting action to an object within a detectable zone of the detecting device; a control circuit, connected between the light source and the detecting device, for controlling the light source to emit the light with a specific intensity or a color according to the detecting action; and a trigger device, connected to the control circuit, for stopping the detecting device executing the detecting action in response to a trigger action when the detecting device is operating in an enable mode; or starting the detecting device to execute the detecting action in response to the trigger action when the detecting device is operating in a disable mode.

In the embodiment, the control circuit further comprises: a front-end processing circuit, connected to the ultrasonic detecting device, for amplifying and filtering the object-distance signal outputted from the ultrasonic detecting device, and outputting the processed object-distance signal; a micro-processor, connected to the front-end processing circuit and the trigger device, for generating a light-control signal according to the processed object-distance signal and outputting a disable or an enable signal in response to the trigger action when the ultrasonic detecting device is operating in the enable or disable modes; a light-source driver, connected between the micro-processor and the light source, for receiving the light-control signal and driving the light source to emit the light according to the light-control signal; and a detecting-device driver, connected between the micro-processor and the detecting device, for receiving the disable signal when the detecting device is operating in the enable mode, and then stopping processing the detecting action; or receiving the enable signal when the detecting device is operating in the disable mode, and then starting the detecting device to execute the detecting action.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a diagram showing a conventional lighting system adopting an ultrasonic detecting device for controlling the light source;

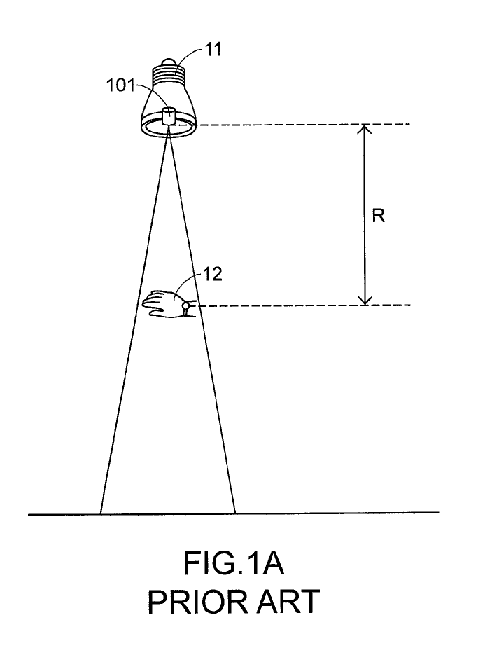

FIG. 1B is block diagram showing the conventional lighting system 11 depicted in FIG. 1A;

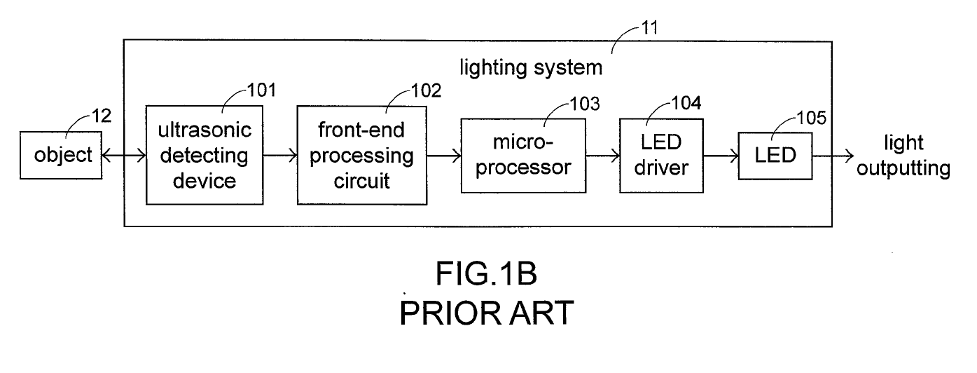

FIG. 2A is a block diagram showing the lighting system of the present invention;

FIG. 2B is another block diagram of the lighting system of the present invention;

FIG. 3 is a block diagram showing a lighting system in the first embodiment of the present invention;

FIG. 4 is a block diagram showing a lighting system in the second embodiment of the present invention;

FIG. 5 is a block diagram showing a lighting system in the third embodiment of the present invention;

FIG. 6 is a block diagram showing a lighting system in the fourth embodiment of the present invention; and

FIG. 7 is a block diagram showing a lighting system in the fifth embodiment of the present invention.

### DETAILED DESCRIPTION OF PREFERRED EMBODIMENTS

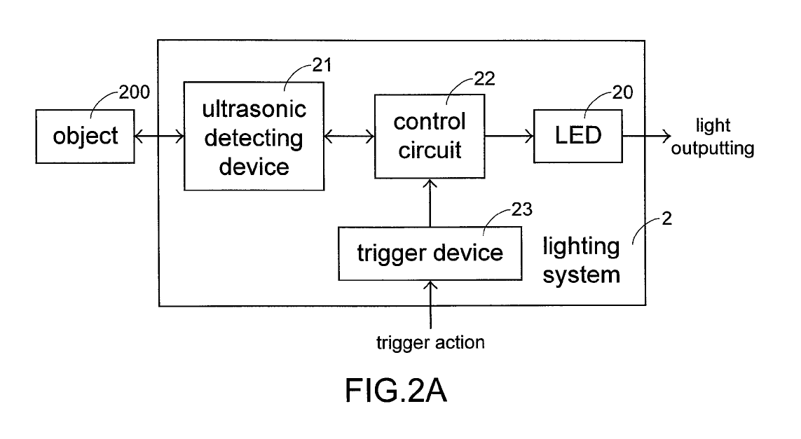

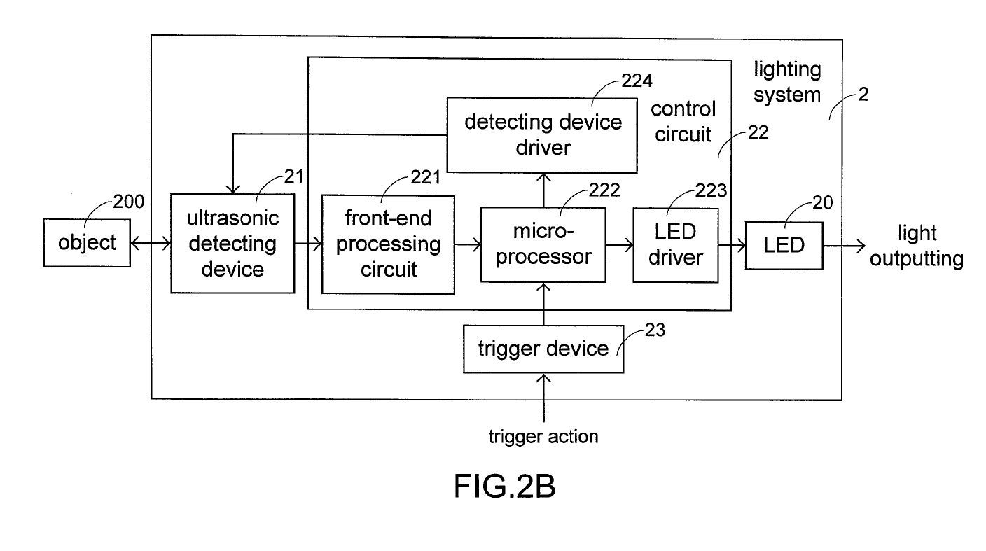

FIG. 2A is a block diagram showing the lighting system of the present invention. As indicated, the lighting system 2 includes: an LED 20 served as a light source for outputting light with different intensity or different color; an ultrasonic detecting device 21; a control circuit 22; and a trigger device 23.

When an object 200 enters a detectable zone of the ultrasonic detecting device 21, an ultrasonic wave, emitted from the ultrasonic detecting device 21, will be reflected by the object and back to a receiver within the ultrasonic detecting device 21. The process of the ultrasonic detecting device 21 emitting ultrasonic waves for detecting the object 200 is referred as a detecting action. When the receiver detects the reflected ultrasonic wave, the distance between the object 200 and the receiver is determined. According to the change of the distance, the ultrasonic detecting device 21 generates an object-distance signal, and then outputs the object-distance signal to the control circuit 22. After receiving the object-distance signal, the control circuit 22 generates a light-control signal according to the object-distance signal, and then outputs the light-control signal to the LED 20. The LED 20 then outputs corresponding light (with a specific intensity or a specific color) according to the light-control signal.

The main characteristic of the lighting system 2 of the present invention is that a trigger device 23 is connected to the control circuit 22. When the ultrasonic detecting device 21 is operating in an enable mode, the trigger device 23 of the present invention can output a trigger signal to the control circuit 22 in response to a trigger action. After receiving the trigger signal, the control circuit 22 first generates a disable signal, and outputs the disable signal to the ultrasonic detecting device 21. After receiving the disable signal, the ultrasonic detecting device 21 then stops processing the detecting action. Alternatively, when the ultrasonic detecting device 21 is operating in a disable mode, the trigger device 23 of the present invention can output the trigger signal to the control circuit 22 in response to the trigger action. After receiving the trigger signal, the control circuit 22 generates an enable signal, and outputs the enable signal to the ultrasonic detecting device 21. After receiving the enable signal, the ultrasonic detecting device 21 then starts to execute the detecting action. In other words, users can independently control the ultrasonic detecting device 21 to operate in the enable or disable modes through the trigger device 23, it follows that the ultrasonic detecting device 21 is not always on when the lighting system 2 is on. And the lifetime of the ultrasonic detecting device 21 is extended.

The function of the lighting system 2 of the present invention is more specifically explained below. FIG. 2B is another block diagram showing the lighting system 2 of the present invention. The control circuit 22 further includes: a front-end processing circuit 221, a micro-processor 222, an LED driver 223, and a detecting-device driver 224. The front-end processing circuit 221, connected between the ultrasonic detecting device 21 and the micro-processor 222, serves to amplify and filter the object-distance signal outputted from the ultrasonic detecting device 21, and then transmits the processed object-distance signal to the micro-processor 222. The micro-processor 222, connected with the trigger device 23 and the LED driver 223, serves to output the light-control signal to the LED driver 223 according to the processed object-distance signal; and outputs the disable or enable signals in response to the trigger action. The LED driver 223, connected to the LED 20, serves to drive the LED 20 to output corresponding light (with a specific intensity or a specific color) according to the light-control signal outputted from the micro-processor 222. The detecting-device driver 224, connected between the micro-processor 222 and the ultrasonic detecting device 21, serves to receive the disable signal when the ultrasonic detecting device 21 is operating in the enable mode, and then stop the detecting action of the ultrasonic detecting device 21; or receive the enable signal when the ultrasonic detecting device 21 is operating in the disable mode, and start the detecting action of the ultrasonic detecting device 21.

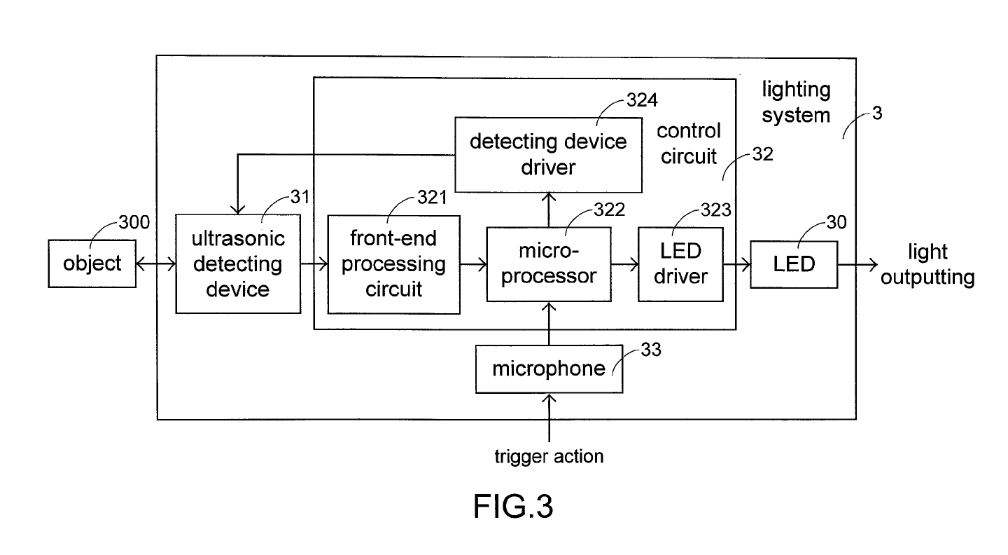

FIG. 3 is a block diagram showing a lighting system in the first embodiment of the present invention. As indicated, the lighting system 3 includes: an LED 30, an ultrasonic detecting device 31, a control circuit 32, and a microphone 33 which functions as the trigger device. The control circuit 32 further includes: a front-end processing circuit 321, a micro-processor 322, an LED driver 323, and a detecting-device driver 324. In the first embodiment of the present invention, users can control the ultrasonic detecting device 31 to enter the enable mode or the disable mode through the microphone 33. For example, when the ultrasonic detecting device 31 is operating in the enable mode and processing the detecting action, users can control the ultrasonic detecting device 31 to enter the disable mode and stop the detecting action through inputting a voice command to the microphone 33. In other words, if users plan to stop the ultrasonic detecting device 31 processing the detecting action, users can input a specific voice command to the microphone 33 (a trigger action). The microphone 33 then generates and outputs the trigger signal to the micro-processor 322. In response to the trigger signal, the micro-processor 322 outputs the disable signal to the detecting-device driver 324; and then the detecting-device driver 224 can control the ultrasonic detecting device 31 to stop the detecting action and enter the disable mode. Similarly, controlling the ultrasonic detecting device 31 to start the detecting action and to enter the enable mode can be achieved through the same manner.

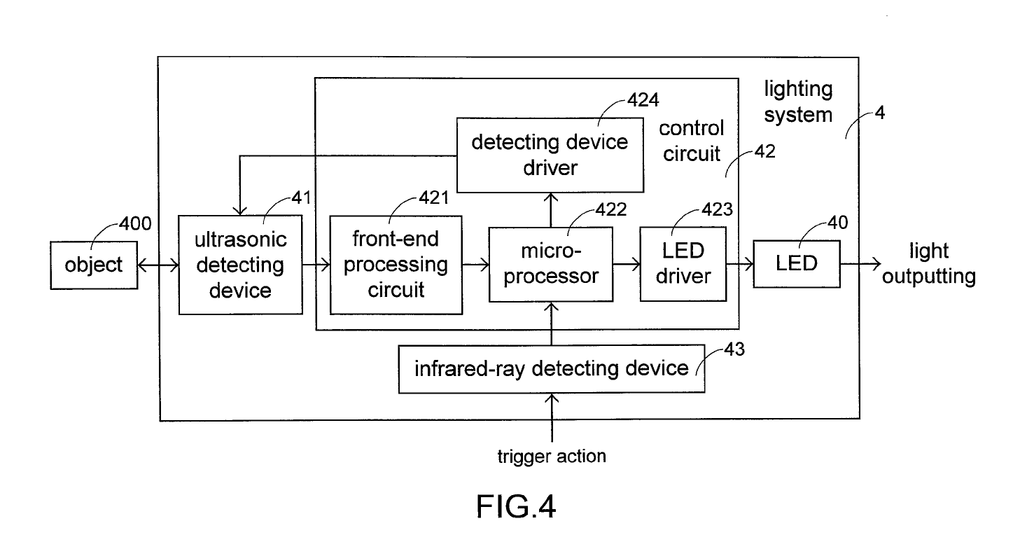

FIG. 4 is a block diagram showing a lighting system in the second embodiment of the present invention. As indicated, the lighting system 4 includes: an LED 40, an ultrasonic detecting device 41, a control circuit 42, and an infrared-ray detecting device 43 which functions as the trigger device. The control circuit 42 further includes: a front-end processing circuit 421, a micro-processor 422, an LED driver 423, and a detecting-device driver 424. In the second embodiment of the present invention, users can control the ultrasonic detecting device 41 to enter the enable mode or the disable mode through the infrared-ray detecting device 43. For example, if users plan to stop the ultrasonic detecting device 41 processing the detecting action, users can move an object, say, user's hand, to a detectable zone of the infrared-ray detecting device 43. The infrared-ray detecting device 43 then generates and outputs the trigger signal to the micro-processor 422 if the infrared-ray detecting device 43 detects the temperature within the detectable zone is up to a predetermined value, say, 30□ (a trigger action). In response to the trigger signal, the micro-processor 422 outputs the disable signal to the detecting-device driver 424; and then the detecting-device driver 424 can control the ultrasonic detecting device 41 to stop the detecting action and enter the disable mode. Similarly, controlling the ultrasonic detecting device 41 to start the detecting action and to enter the enable mode can be achieved through the same manner.

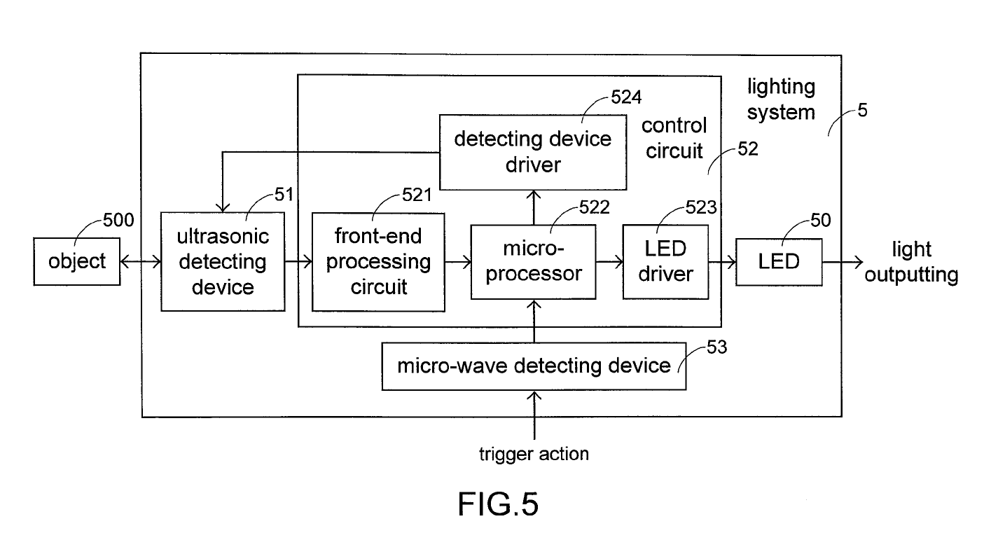

FIG. 5 is a block diagram showing a lighting system in the third embodiment of the present invention. As indicated, the lighting system 5 includes: an LED 50, an ultrasonic detecting device 51, a control circuit 52, and a micro-wave detecting device 53 which functions as the trigger device. The control circuit 52 further includes: a front-end processing circuit 521, a micro-processor 522, an LED driver 523, and a detecting-device driver 524. In the third embodiment of the present invention, users can control the ultrasonic detecting device 51 to enter the enable mode or the disable mode through the micro-wave detecting device 53. For example, if users plan to stop the ultrasonic detecting device 51 processing the detecting action, users can move an object, say, user's hand, to a detectable zone of the micro-wave detecting device 53. The micro-wave detecting device 53 then generates and outputs the trigger signal to the micro-processor 522 if the micro-wave detecting device 53 detects the change of the standing wave is larger than a predetermined value (a trigger action). In response to the trigger signal, the micro-processor 522 outputs the disable signal to the detecting-device driver 524; and then the detecting-device driver 524 can control the ultrasonic detecting device 51 to stop the detecting action and enter the disable mode. Similarly, controlling the ultrasonic detecting device 51 to start the detecting action and to enter the enable mode can be achieved through the same manner.

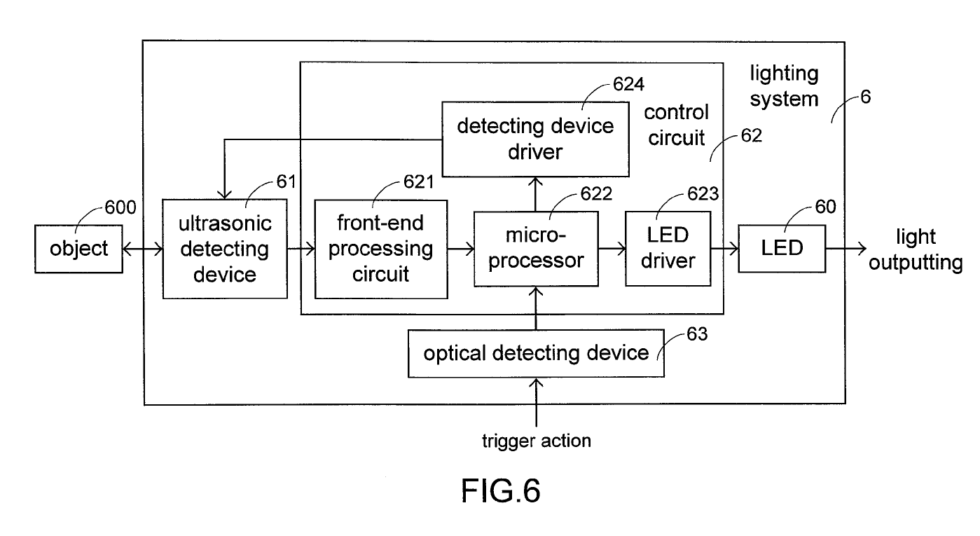

FIG. 6 is a block diagram showing a lighting system in the fourth embodiment of the present invention. As indicated, the lighting system 6 includes: an LED 60, an ultrasonic detecting device 61, a control circuit 62, and an optical detecting device 63 which functions as the trigger device. The control circuit 62 further includes: a front-end processing circuit 621, a micro-processor 622, an LED driver 623, and a detecting-device driver 624. In the fourth embodiment of the present invention, users can control the ultrasonic detecting device 61 to enter the enable mode or the disable mode through the optical detecting device 63. For example, if users plan to stop the ultrasonic detecting device 61 processing the detecting action, users can move an object, say, user's hand, to a detectable zone of the optical detecting device 63. The optical detecting device 63 then generates and outputs the trigger signal to the micro-processor 622 if the optical detecting device 63 detects the illumination is down to a predetermined value (a trigger action). In response to the trigger signal, the micro-processor 622 outputs the disable signal to the detecting-device driver 624; and then the detecting-device driver 624 can control the ultrasonic detecting device 61 to stop the detecting action and enter the disable mode. Similarly, controlling the ultrasonic detecting device 61 to start the detecting action and to enter the enable mode can be achieved through the same manner.

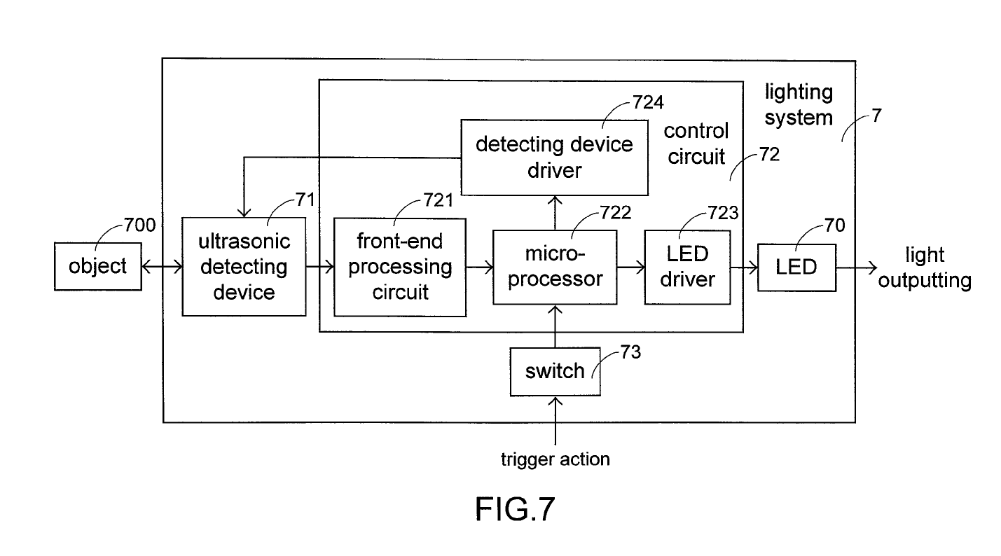

FIG. 7 is a block diagram showing a lighting system in the fifth embodiment of the present invention. As indicated, the lighting system 7 includes: an LED 70, an ultrasonic detecting device 71, a control circuit 72, and a switch 73 which functions as the trigger device. The control circuit 72 further includes: a front-end processing circuit 721, a micro-processor 722, an LED driver 723, and a detecting-device driver 724. In the fifth embodiment of the present invention, users can control the ultrasonic detecting device 71 to enter the enable mode or the disable mode through the switch 73. For example, if users plan to stop the ultrasonic detecting device 71 processing the detecting action, users can turn the switch 73 to the close position (a trigger action). The switch 73 then generates and outputs the trigger signal to the micro-processor 722. In response to the trigger signal, the micro-processor 722 outputs the disable signal to the detecting-device driver 724; and then the detecting-device driver 724 can control the ultrasonic detecting device 71 to stop the detecting action and enter the disable mode. Similarly, controlling the ultrasonic detecting device 71 to start the detecting action and to enter the enable mode can be achieved through the same manner.

Therefore, through the trigger device in the embodiments of the present, users can control the ultrasonic detecting device to enter the enable or disable modes. In other words, users can independently turn off the ultrasonic detecting device through the trigger device when the ultrasonic detecting device is not on duty. Because the ultrasonic detecting device can be switched between the enable and the disable modes, it follows that the lifetime of the ultrasonic detecting device is longer than that of the conventional lighting system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A lighting system comprising:
a light source for emitting a light;
a detecting device for executing a detecting action to an object within a detectable zone of the detecting device;
a control circuit, connected between the light source and the detecting device, for controlling the light source to emit a light with a specific intensity or a specific color according to the detecting action; and
a trigger device, connected to the control circuit, for stopping the detecting device executing the detecting action in response to a trigger action when the detecting device is operating in an enable mode; or for starting the detecting device to execute the detecting action in response to the trigger action when the detecting device is operating in a disable mode.

2. The lighting system according to claim 1, wherein the light source is an LED.

3. The lighting system according to claim 1, wherein the detecting device is an ultrasonic detecting device and the detecting action is the process of the ultrasonic detecting device: emitting an ultrasonic wave; generating an object-distance signal to the control circuit if the ultrasonic wave is reflected by an object and received by a receiver within the ultrasonic detecting device.

4. The lighting system according to claim 3, wherein the control circuit further comprises:
a front-end processing circuit, connected to the ultrasonic detecting device, capable of amplifying and filtering the object-distance signal outputted from the ultrasonic detecting device, and then outputting the processed object-distance signal;
a micro-processor, connected to the front-end processing circuit and the trigger device, capable of generating a light-control signal according to the processed object-distance signal; and outputting a disable or an enable signal in response to the trigger action when the ultrasonic detecting device is operating in the enable or disable modes, respectively;
a light-source driver, connected between the micro-processor and the light source, capable of receiving the light-control signal and driving the light source to emit the light according to the light-control signal; and
a detecting-device driver, connected between the micro-processor and the detecting device, capable of receiving the disable signal when the detecting device is operating in the enable mode, and then stopping processing the detecting action; or receiving the enable signal when the detecting device is operating in the disable mode, and starting the detecting device to execute the detecting action.

5. The lighting system according to claim 1, wherein the trigger device is a microphone for receiving a voice command and the trigger action is that the microphone receives the voice command and outputs a trigger signal in response to the trigger action.

6. The lighting system according to claim 1, wherein the trigger device is an infrared-ray detecting device for detecting an object entering a detectable zone of the infrared-ray detecting device and the trigger action is that the infrared-ray detecting device detects if the temperature within the detectable zone of the infrared-ray detecting device is up to a predetermined value; and then the infrared-ray detecting device can output a trigger signal in response to the trigger action.

7. The lighting system according to claim 1, wherein the trigger device is a micro-wave detecting device for detecting an object entering a detectable zone of the micro-wave detecting device and the trigger action is that the micro-wave detecting device detects the change of the standing wave in the detectable zone of the micro-wave detecting device is larger than a predetermined value; and then the micro-wave detecting device can output a trigger signal in response to the trigger action.

8. The lighting system according to claim 1, wherein the trigger device is an optical detecting device for detecting an illumination in a detectable zone of the optical detecting device and the trigger action is that the optical detecting device detects the illumination in the detectable zone of the optical detecting device is down to a predetermined value; and then the optical detecting device can output a trigger signal in response to the trigger action.

9. The lighting system according to claim 1, wherein the trigger device is a switch having a first position and a second position and the trigger action is that the switch is turned to the first position when the detecting device is operating in the enable mode, or the switch is turned to the second position when the detecting device is operating in the disable mode.
